(19) United States
(12) Patent Application Publication
(10) Pub. No.: US 2026/0295612 A1
(43) Pub. Date: Oct. 1, 2026

(54) A SPRAYER

(71) Applicant: IVM IP PTY LTD, Varsity Lakes, Queensland (AU)

(72) Inventors: Christopher Conway LAMB, Red Hill QLD (AU); Nicholas BLOOR, Red Hill QLD (AU)

(21) Appl. No.: 19/476,808

(22) PCT Filed: Apr. 19, 2024
(86) PCT No.: PCT/AU2024/050378

§ 371 Date: Oct. 21, 2025

(30) Foreign Application Priority Data
Apr. 21, 2023 (AU) 2023901191

(51) Int. Cl. B05B 7/24; A01C 23/04

(52) U.S. Cl. CPC B05B 7/2443; A01C 23/047; B05B 7/2481

(57) ABSTRACT

A sprayer for attachment to a hose includes an inlet for introducing fluid into the sprayer, an outlet for discharging fluid from the sprayer, a first controller to control the flow of fluid from the inlet to the outlet, a first fluid path located between the first controller and the outlet, a second fluid path fluidly connectable to a container having an active liquid, and a venturi arrangement located in line with the first fluid path. The venturi arrangement is adapted to introduce fluid from the second fluid path into the first fluid path.

### FIELD OF INVENTION

The present invention relates to a sprayer. Reference will be made in the specification to the use of the sprayer with respect to a hose. The patent specification describes this use but it is by way of example only and the invention is not limited to this use.

### BACKGROUND OF THE INVENTION

Sprayers used for applying an active liquid solution that contains weedkiller, fertiliser, or pesticides mixed with water are widely utilized for maintaining lawns and caring for plants. These devices, which are generally attached to a garden hose, depend on the hose's water pressure to effectively disperse the liquid from a reservoir to the targeted area. Despite their widespread use, numerous challenges associated with these sprayers must be addressed to enhance their functionality and user safety.

A significant issue with traditional sprayers is their inability to provide users with precise control over the quantity of active liquid dispensed. This can lead to uneven distribution, which might result in the excessive or insufficient application of weedkillers, fertilisers, or pesticides. Such discrepancies can fail to achieve the intended outcomes, leaving areas of the lawn or plants either over-treated or under-treated. This lack of precision can be particularly frustrating for individuals who need exact application rates to ensure effective care and maintenance of their lawns and gardens.

Furthermore, existing sprayer container combinations are often disposable and not designed for easy refilling. This approach not only contributes to environmental waste but also imposes additional costs on consumers who must purchase new sprayer container combinations each time their supply of active liquid depletes. The process of refilling these containers with a new mixture of concentrate and water is not only cumbersome but also critical, as it requires careful preparation to achieve the correct concentration of the active liquid. Incorrect mixing can lead to solutions that are either too strong or too dilute, potentially causing ineffective treatment or damage to the plants and soil. Furthermore, the risks associated with handling chemicals during the refilling process, such as potential skin irritation, eye injuries, or the inhalation of toxic fumes, significantly increase the health and safety hazards for the users.

### OBJECT OF THE INVENTION

It is an object of the present invention to overcome or at least alleviate one or more of the above mentioned problems with sprayers and/or provide the consumer with a useful or commercial choice.

### SUMMARY OF THE INVENTION

In one aspect, the present invention broadly resides in a sprayer for attachment to a hose, the sprayer including
an inlet for introducing fluid into the sprayer;
an outlet for discharging fluid from the sprayer;
a first controller to control the flow of fluid from the inlet to the outlet;
a first fluid path located between the first controller and the outlet;
a second fluid path fluidly connectable to a container having an active liquid; and
a venturi arrangement located in line with the first fluid path, the venturi arrangement adapted to introduce fluid from the second fluid path into the first fluid path.

Preferably the sprayer further includes a second controller to control the flow of active liquid in the second fluid path. Preferably the second controller is actuated by the first controller. Preferably the second controller is operatively attached to the first controller.

Preferably the sprayer further includes a third controller to control the flow of fluid through the venturi arrangement.

In another aspect, the present invention broadly resides in a sprayer for attachment to a hose, the sprayer including
an inlet for introducing fluid into the sprayer;
an outlet for discharging fluid from the sprayer;
a first controller to control the flow of fluid from the inlet to the outlet;
a first fluid path located between the first controller and the outlet;
a second fluid path fluidly connectable to a container having an active liquid;
a second controller to control the flow of active liquid in the second fluid path;
a venturi arrangement located in line with the first fluid path, the venturi arrangement adapted to introduce fluid from the second fluid path into the first fluid path; and
a third controller to control the flow of fluid through the venturi arrangement.

The fluid is preferably a liquid. More preferably the fluid is water.

The inlet preferably includes a hose coupling. Preferably the hose coupling is attachable to a garden hose. More preferably the hose coupling is attachable to a hose connector of a garden hose.

The outlet preferably includes a nozzle to discharge the fluid. The nozzle preferably sprays the fluid. In one embodiment, the outlet includes a plurality of nozzles. Preferably a desired nozzle is selectable from the plurality of nozzles. The outlet preferably includes a selector ring to select a desired nozzle from the plurality of nozzles. In another embodiment, the outlet includes an adjustable nozzle.

In the embodiment where the outlet includes a plurality of nozzles, the outlet includes a plurality of vents adjacent to nozzle openings, such that when the nozzles are being changed, a vent and/or nozzle opening is always in fluid communication with the outlet. Preferably the sprayer includes a nozzle assembly which includes the plurality of nozzles and the plurality of vents. Preferably the nozzle assembly further includes a fluid jacket, preferably the fluid jacked is in fluid communication with the plurality of vents. Preferably the fluid jacked is in further fluid communication with one or more vent openings which enable fluid in the fluid jacket to exit the nozzle assembly.

In one embodiment the venturi arrangement includes a variable geometry mechanism. Preferably the variable geometry mechanism is able to change the geometry of the venturi arrangement to increase or decrease the flowrate and/or the speed of the fluid moving through the venturi arrangement. Preferably the variable geometry mechanism is able to increase or decrease and effective cross sectional area of the venturi arrangement. Preferably the variable geometry mechanism includes at least one member which can be moved into or out of relative to the venturi arrangement to change an effective cross sectional area of the venturi arrangement. Preferably the at least one member are two members which engage with each other. Preferably each of the two members is pivotably attached relative to the sprayer toward one end of the respective members. Preferably the variable geometry mechanism is controlled by the third controller. Preferably the third controller is a screw type controller. Preferably the screw type controller pushes the at least one member in towards the venturi arrangement when the screw type of controller is screwed in relative to the sprayer. Preferably the at least one member is biased outwardly from the venturi arrangement. Preferably when the screw type controller is unscrewed relative to the sprayer, the at least one member is biased outwardly increasing an effective cross sectional area of the venturi arrangement.

Preferably, the sprayer includes a bypass path. Preferably the bypass path is fluidly connected to the first fluid path before the venturi arrangement and after the venturi arrangement. Preferably the third controller controls an amount of fluid which flows through the bypass path. Preferably in this embodiment, the third controller is a valve. Preferably, the third controller is a 3-way valve. Preferably the third controller is adapted to divert a portion of the fluid through the bypass path. Preferably the third controller is adapted to divert all the fluid through the venturi arrangement. Preferably the third controller is adapted to divert all of the fluid through the bypass path.

In another embodiment, the sprayer includes an air bleed mechanism. Preferably the air bleed mechanism controls how much air can bleed into the venturi arrangement to control the flow rate or speed of the fluid through the venturi arrangement. Preferably the air bleed arrangement includes a plurality of different sized holes, wherein a hole of a desired size can be selected to control the air bleed mechanism. Preferably the third controller controls the air bleed mechanism. In another embodiment, the third controller is part of the air bleed mechanism. Preferably the air bleed mechanism further includes a one-way valve to prevent fluid from the venturi arrangement from exiting the sprayer through the air bleed mechanism.

Preferably the sprayer further includes a pressure cut off valve. Preferably the pressure cut off valve is adapted to prevent flow of fluid through the second fluid path. Preferably the pressure cut off valve is movable between a flow condition and a shut off condition. Preferably the pressure cut off valve is biased towards the shut off condition in which flow of fluid through the second fluid path is inhibited. Preferably pressure in the first fluid path moves the pressure cut off valve to the flow condition in which fluid can flow through the second fluid path. Preferably the pressure cut of valve is fluidly connected to the first fluid path at a point before the venturi arrangement and at a point after the venturi arrangement.

The first controller preferably includes a valve. The first controller preferably includes a trigger. When actuated, the trigger preferably opens the first controller valve. Preferably when the first controller valve is open, the fluid flows through the first fluid path. The trigger is preferably located on a handle of the sprayer.

The first fluid path is preferably a duct. More preferably the first fluid path is a tube.

Preferably the second controller includes a valve. The second controller preferably includes a switch. When actuated, the switch preferably opens the second controller valve. Preferably when the second controller is actuated active liquid flows through the second fluid path. Preferably when the second controller is actuated active liquid can flow through the second fluid path dependant on other controllers. It will be realised that active liquid may also be referred to as fluid in this specification. In one embodiment, the second controller is actuated when the first controller is actuated. Preferably in this embodiment, the second controller is one or more linkages operatively attached to the first controller.

The second fluid path is preferably a duct. More preferably the second fluid path is a tube. The second fluid path may include a pick-up tube located in the container.

The sprayer preferably includes the container. The container is preferably a collapsible bladder. In one embodiment, the container is a rigid container.

The sprayer preferably includes a connector to connect to the container.

In one embodiment, the connector has a threaded portion which engages with a threaded portion on the container. In one embodiment, the connection between the connector and the container is a cam and groove type connection or similar connection.

Preferably the container includes a one-way valve to enable air to be introduced into the container.

Preferably the container includes a male connector. Preferably the sprayer includes a female connector. Preferably the male connector is adapted to releasably engage with the female connector. Preferably the sprayer includes one or more engagement portions which are adapted to engage with a recess on the male connector to releasably secure the male connector to the female connector.

Preferably the container has one or more locating portions to assist in aligning the container with the sprayer when the container is connected to the sprayer. Preferably the sprayer has one or more corresponding locating portions. Preferably the one or more locating portions on the container are protrusions and the one or more locating portions on the sprayer are corresponding recesses. In another embodiment, the one or more locating portions on the container are recesses and the one or more locating portions on the sprayer are corresponding protrusions. Preferably the one or more locating portions on the container are semi circular recesses. Preferably the one or more locating portions on the container are a plurality of locating portions. Preferably the plurality of locating portions are 4 to 8 locating portions. More preferably the plurality of locating portions are 6 locating portions. Preferably the one or more locating portions on the container are located on a lip of the container.

Preferably the container includes an anti drip valve. Preferably the anti drip valve is biased into a closed condition. Preferably in the closed condition, the container is closed. Preferably when the container is connected to the sprayer, the anti drip valve is moved to an open condition. Preferably in the open condition active liquid can flow from the container to the second fluid path. Preferably the anti drip valve is biased to the closed condition by a spring.

Preferably the sprayer includes an anti drip valve. Preferably the anti drip valve is biased into a closed condition. Preferably in the closed condition, the second fluid path is closed. Preferably when the container is connected to the sprayer, the anti drip valve is moved to an open condition. Preferably in the open condition active liquid can flow from the container to the second fluid path. Preferably the anti drip valve is biased to the closed condition by a spring.

Preferably the container includes a cap. Preferably the cap is located over an opening of the container. Preferably the cap is a tamper evident cap. Preferably the tamper evident cap has one or more breakable tabs that must be broken to access the opening of the container. Preferably the cap is tethered to the container. Preferably the cap can be reused to close the container.

In a less preferred embodiment, containers having different active liquids have different arrangements that engage with the third controller to change the rate at which the active liquid moves from the containers.

In one embodiment, the sprayer preferably includes a flow indicator. The flow indicator preferably indicates the flow of active liquid from the container. Preferably the flow indicator is one of a ball, rotor or impeller flow indicator.

The container preferably has a one way opening. The one way opening preferably allows the active liquid to flow from the container and prevents liquid from entering the container. In one embodiment, the one way opening includes a one way valve. In another embodiment, the one way opening includes a one way membrane. In a further embodiment, a venturi arrangement acts as a one way opening.

Preferably when fluid is flowing in the first fluid path, the fluid flow causes a reduction in fluid pressure in the venturi arrangement, drawing the active liquid through the second fluid path from the container. Preferably the active liquid from the container is drawn into the fluid flow in the first fluid path and is discharged from the outlet.

In one embodiment the sprayer includes a pressure reduction valve to regulate the pressure of fluid being introduced via the inlet.

In one embodiment the sprayer includes a one way valve to prevent active liquid from flowing to the inlet.

In a further aspect, the present invention broadly resides in a sprayer for attachment to a hose, the sprayer including
an inlet for introducing fluid into the sprayer;
an outlet for discharging fluid from the sprayer;
a first controller to control the flow of fluid from the inlet to the outlet;
a first fluid path located between the first controller and the outlet;
a container having an active liquid;
a second fluid path fluidly connectable to the container;
a second controller to control the flow of fluid in the second fluid path;
a venturi arrangement located in line with the first fluid path, the venturi arrangement adapted to introduce fluid from the second fluid path into the first fluid path; and
a third controller to control the flow of fluid through the venturi arrangement.

In another aspect, the present invention broadly resides in a sprayer for attachment to a hose, the sprayer including
an inlet for introducing fluid into the sprayer;
an outlet for discharging fluid from the sprayer;
a first controller to control the flow of fluid from the inlet into the sprayer;
a first fluid path located between the first controller and the outlet;
a container having an active liquid;
a second fluid path fluidly connectable to the container;
a venturi arrangement located in line with the first fluid path, the venturi arrangement adapted to introduce fluid from the second fluid path into the first fluid path; and
a third controller to control the flow of fluid through the venturi arrangement.

Preferably the first controller is adapted to control the flow of fluid from the inlet to the outlet.

Preferably the sprayer includes a second controller to control the flow of fluid in the second fluid path.

In one embodiment, the sprayer further includes a control arrangement to control the flow of fluid through the venturi arrangement.

Preferably the control arrangement includes a pickup tube having a predetermined internal diameter located between the second fluid path and the container. Preferably a larger diameter results in a greater flow rate than a smaller diameter. In one embodiment, the pickup tube is part of the second fluid path. Preferably the pickup tube is part of the container.

In one embodiment, the control arrangement includes a throttling valve to control the flow rate in the second fluid path. In one embodiment the throttling valve is connected to the sprayer. In another embodiment, the throttling valve is part of the container.

In one aspect, the present invention broadly resides in a sprayer for attachment to a hose, the sprayer including
an inlet for introducing fluid into the sprayer;
an outlet for discharging fluid from the sprayer;
a first controller to control the flow of fluid from the inlet to the outlet;
a first fluid path located between the first controller and the outlet;
a second fluid path fluidly connectable to a container having an active liquid;
a second controller to control the flow of fluid in the second fluid path;
a venturi arrangement located in line with the first fluid path, the venturi arrangement adapted to introduce fluid from the second fluid path into the first fluid path; and
a control arrangement to control the flow of fluid through the venturi arrangement.

Preferably the control arrangement includes a pickup tube having a predetermined internal diameter located between the second fluid path and the container. Preferably a larger diameter results in a greater flow rate than a smaller diameter. In one embodiment, the pickup tube is part of the second fluid path.

In one embodiment, the control arrangement includes a throttling valve to control the flow rate in the second fluid path.

In a further aspect, the present invention broadly resides in a method of spraying an active liquid using a sprayer as described in this specification, the method including the steps of
introducing fluid into the sprayer via the inlet;
actuating the first controller to enable fluid to flow through the first fluid path;
actuating the second controller to enable active liquid from the container to flow into the second fluid path and be drawn into the venturi arrangement such that it flows into the first fluid path and is discharged from the outlet.

Preferably the method further includes the step of using the third controller to control the rate of flow through the venturi arrangement.

In one embodiment, the method further includes the step of indicating the flow of active liquid from the container using a flow indicator.

Preferably the active liquid includes weedkiller, fertiliser, and/or pesticides. In another embodiment, the active liquid includes a cleaning product. In one embodiment, the active liquid includes a vehicle wash formulation.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a schematic side view of a sprayer according to an embodiment of the present invention;

FIG. 2 is a schematic section view of the sprayer of FIG. 1;

FIG. 3 is a schematic section view of a sprayer according to an embodiment of the invention having a variable geometry mechanism;

FIG. 4 is a detailed view of FIG. 3;

FIG. 5 is a schematic section view of a sprayer according to an embodiment of the invention having a bypass path;

FIG. 6 is a schematic section view of the sprayer of FIG. 5;

FIG. 7 is a schematic section view of a sprayer according to an embodiment of the invention having an air bleed mechanism;

FIG. 8 is a schematic section view of a sprayer according to an embodiment of the invention showing a pressure cut off valve;

FIG. 9 is a schematic section view showing a nozzle assembly according to an embodiment of the invention with vent openings;

FIG. 10 is a schematic section view of the nozzle assembly of FIG. 9;

FIG. 11 is a schematic section view of a sprayer according to an embodiment of the invention having a throttling valve;

FIG. 12 is a schematic section view of a sprayer according to an embodiment of the invention having a throttling valve incorporated with the container;

FIG. 13 is a schematic section view of a sprayer according to an embodiment of the invention with a container having a larger pickup tube;

FIG. 14 is a schematic section view of sprayer according to an embodiment of the invention with a container having a smaller pickup tube;

FIG. 15 is a schematic view of a container according to an embodiment of the invention;

FIG. 16 is a schematic section view of the container of FIG. 15;

FIG. 17 is a schematic view of the connector of FIG. 15;

FIG. 18 is a schematic section view of the connector of FIG. 17;

FIG. 19 is a schematic section view of the connector of FIG. 17;

FIG. 20 is a schematic section view of the connector of FIG. 17;

FIG. 21 is a schematic view of a connector and a portion of a sprayer according to an embodiment of the invention;

FIG. 22 is a schematic view of the connector and a portion of a sprayer of FIG. 21;

FIG. 23 is a schematic view of the connector and a portion of a sprayer of FIG. 21;

FIG. 24 is a schematic view of a portion of a container and a cap according to an embodiment of the invention;

FIG. 25 is a schematic section view of the portion of a container and the cap of FIG. 24

FIG. 26 is a perspective view of a bypass and venturi arrangement according to an embodiment of the present invention;

FIG. 27 is a sectioned view of the bypass and venturi arrangement of FIG. 26;

FIG. 28 is a perspective view of the controller for the bypass and venturi arrangement of FIG. 26;

FIG. 29A is a transparent end view of the bypass and venturi arrangement of FIG. 26 in a configuration for fluid to flow 100% through the venturi;

FIG. 29B is a transparent side view of the bypass and venturi arrangement of FIG. 29A;

FIG. 30A is a transparent end view of the bypass and venturi arrangement of FIG. 26 in a configuration for fluid to flow 50% through the venturi and 50% through the bypass;

FIG. 30B is a transparent side view of the bypass and venturi arrangement of FIG. 30A;

FIG. 31A is a transparent end view of the bypass and venturi arrangement of FIG. 26 in a configuration for fluid to flow 100% through the bypass;

FIG. 31B is a transparent side view of the bypass and venturi arrangement of FIG. 31A;

FIG. 32 is a perspective view of a connector for a container according to an embodiment of the present invention;

FIG. 33 is a top view of the connector of FIG. 32; and

FIG. 34 is a section view of a sprayer according to an embodiment of the present invention.

### DETAILED DESCRIPTION OF THE PREFERRED EMBODIMENT

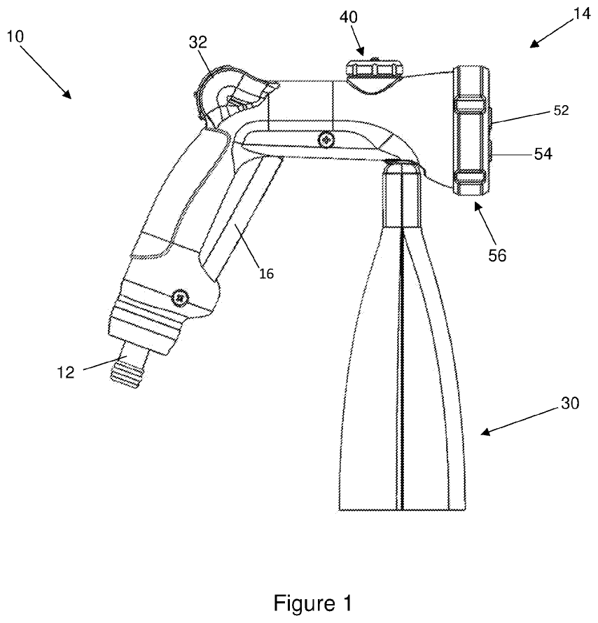

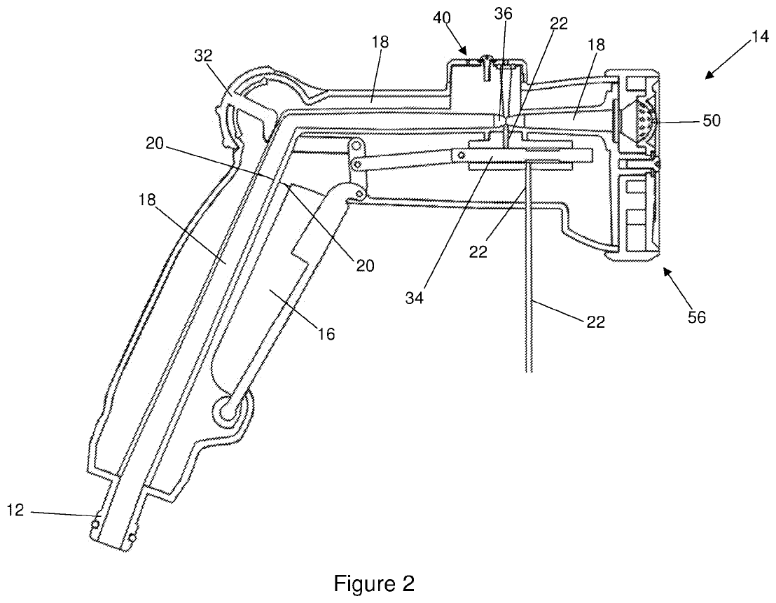

With reference to FIGS. 1 and 2, there is shown a sprayer 10 according to a preferred embodiment of the present invention. The sprayer 10 has an inlet 12 for introducing water into the sprayer 10. The Inlet 12 is in the form of a hose coupling adapted to be connected to a hose (not shown). The sprayer 10 has an outlet 14 for discharging fluid from the sprayer 10. The sprayer 10 has a first controller 16 to control the flow of fluid from the inlet 12 to the outlet 14. A first fluid path 18 is located between the first controller 16 and the outlet 14. A valve 20 of the first controller 16 controls the flow of fluid from the inlet 12 to the outlet 14. In the embodiment shown, the first fluid path 18 is also located between the first controller 16 and the inlet 12.

A second fluid path 22 is fluidly connectable to a container 30 having an active liquid. A second controller 32 controls the flow of active liquid in the second fluid path 22. The second controller 32 includes a valve 34 to control the flow of active liquid in the second fluid path 22.

The sprayer 10 has a venturi arrangement 36 located in line with the first fluid path 18. The venturi arrangement 36 is adapted to introduce active liquid from the second fluid path 22 into the first fluid path 18.

The sprayer 10 has a third controller 40 to control the flow of fluid through the venturi arrangement 36.

The outlet 14 includes a plurality of nozzles 50,52,54 to discharge the fluid. A desired nozzle is selectable from the plurality of nozzles 50,52,54 by twisting the nozzle assembly 56 relative to the sprayer 10.

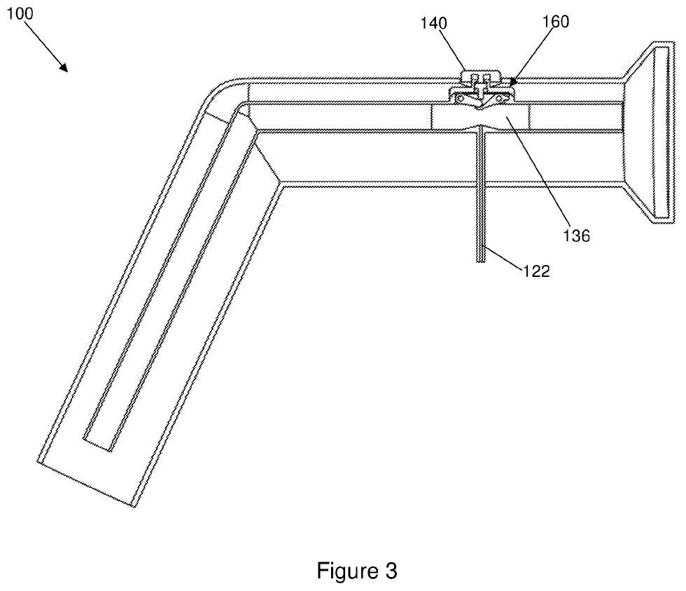

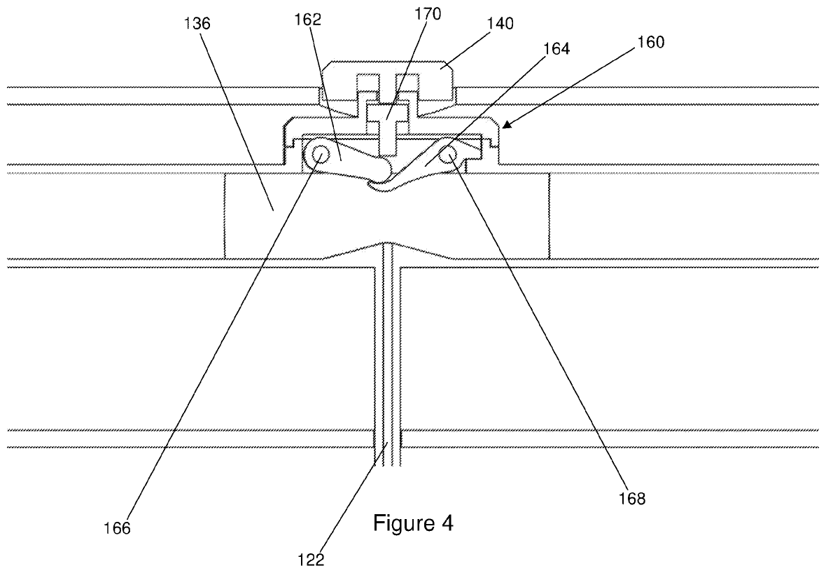

With reference to FIGS. 3 and 4, there is shown a sprayer 100 according to an embodiment of the invention. The sprayer 100 has a variable geometry mechanism 160 as part of the venturi arrangement 136. The variable geometry mechanism 160 is controlled by a third controller 140. The variable geometry mechanism 160 is adapted to change a cross sectional area of the venturi arrangement 136 to change the flow of fluid through the venturi arrangement 136 to adjust the rate at which fluid is drawn from a second fluid path 122 into the venturi arrangement 136.

The variable geometry mechanism 160 has two members 162 and 164 which can pivot relative to each other about pivots 166,168. The two members 162 and 164 are spring loaded and are moved by push member 170, push member 170 is moved by the third controller 140 which can be screwed inwardly or outwardly relative to the variable geometry mechanism 160.

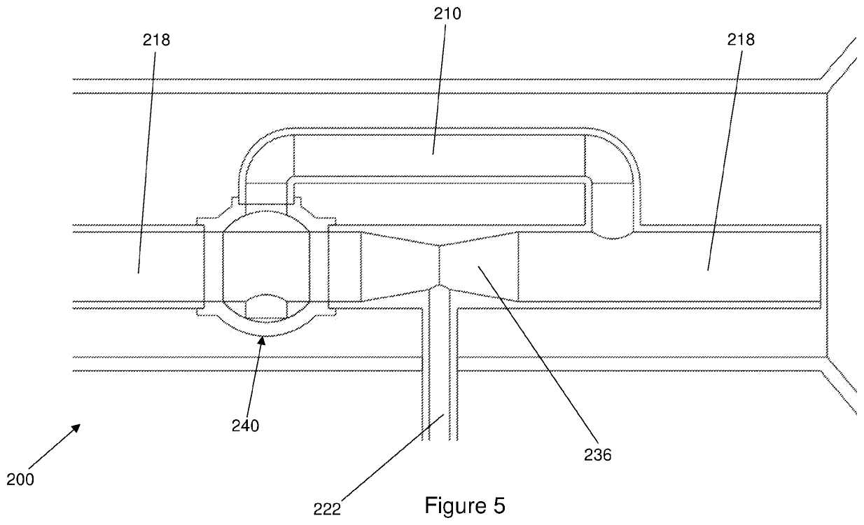

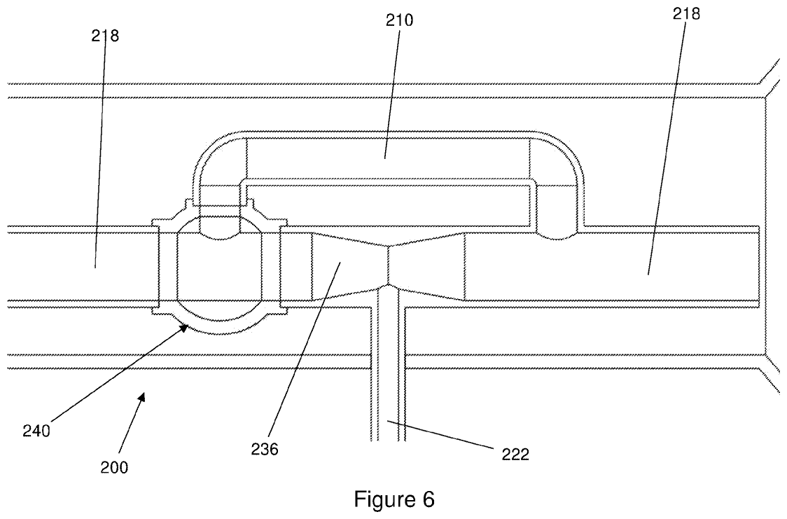

With reference to FIGS. 5 and 6, there is shown part of a sprayer 200 according to an embodiment of the invention. The sprayer 200 has a bypass path 210. The bypass path 210 attaches to a first fluid path 218 in front of and behind a venturi arrangement 236. A third controller 240 controls the amount of fluid in the first fluid path 218 which flows through the venturi arrangement 236 to adjust the rate at which fluid is drawn from a second fluid path 222 into the venturi arrangement 236. The third controller 240 can be adjusted to direct all of the flow of fluid through the venturi arrangement 236 (as shown in FIG. 5), or a part of the fluid flow through the venturi arrangement 236 and a part through the bypass path 210 (as shown in FIG. 6). The third controller 240 can also be adjusted to direct all of the flow of fluid through the bypass path 210 (not shown).

With reference to FIG. 7, there is shown a sprayer 300 according to an embodiment of the invention. The sprayer 300 has a bleed mechanism 360 as part of the venturi arrangement 336. A third controller 340 with a plurality of different sized opening 342,344 controls how much air can enter the bleed mechanism 360 to change the flow of fluid through the venturi arrangement 336 to adjust the rate at which fluid is drawn from a second fluid path 322 into the venturi arrangement 336. The third controller 340 can be twisted to select a desired opening 342,344 or to completely shut of air to the bleed mechanism 360.

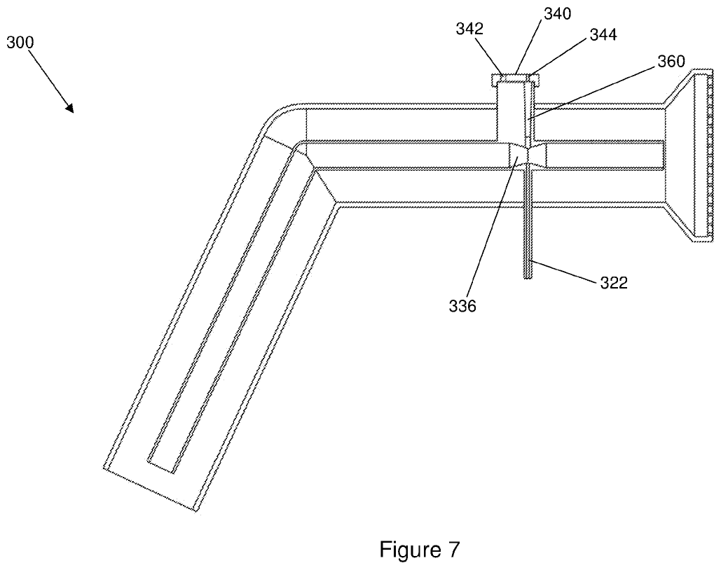

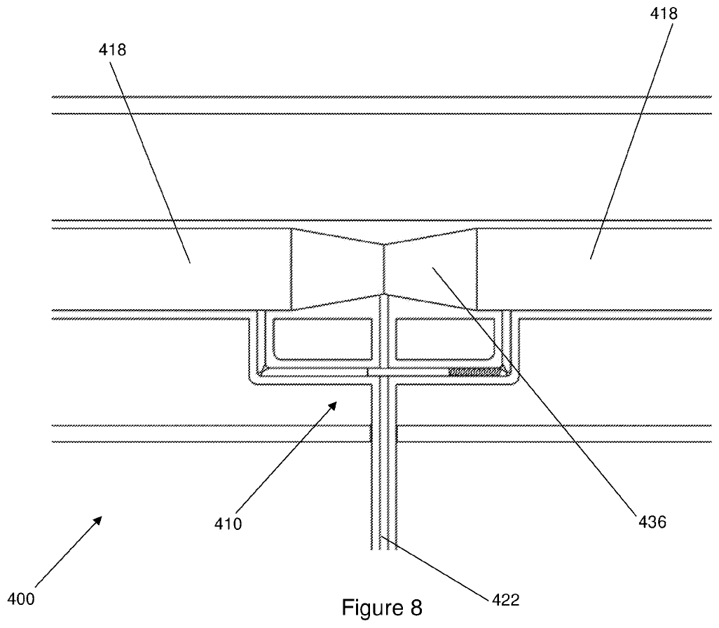

With reference to FIG. 8, there is shown a part of a sprayer 400 according to an embodiment of the invention. The sprayer 400 includes a pressure cut off valve 410. The pressure cut off valve 400 is fluidly connected to the first fluid path 418 in front of and behind the venturi arrangement 436. When there is no or very little flow of fluid in the first fluid path 418, the pressure cut off valve is biased into a closed condition (shown) preventing flow of fluid in the second fluid path 422. It will be understood that when there is sufficient flow of fluid in the first fluid path 418, then the pressure cut off valve 410 will be biased into an open condition enabling flow of fluid in the second fluid path.

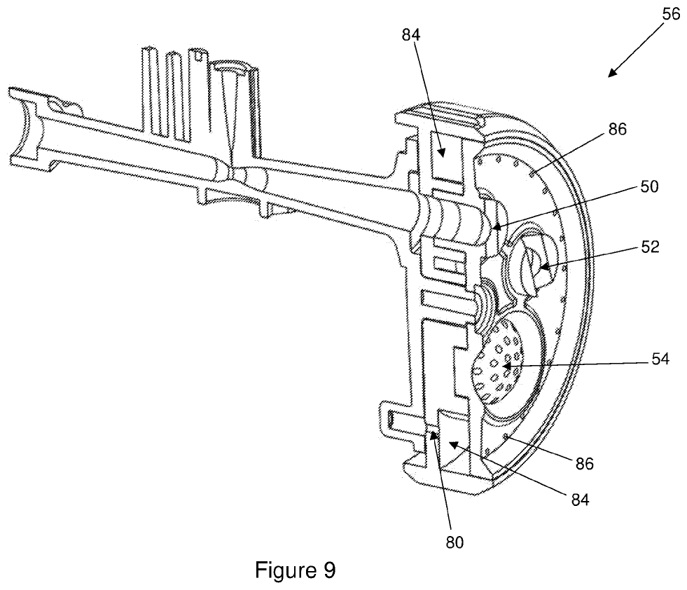

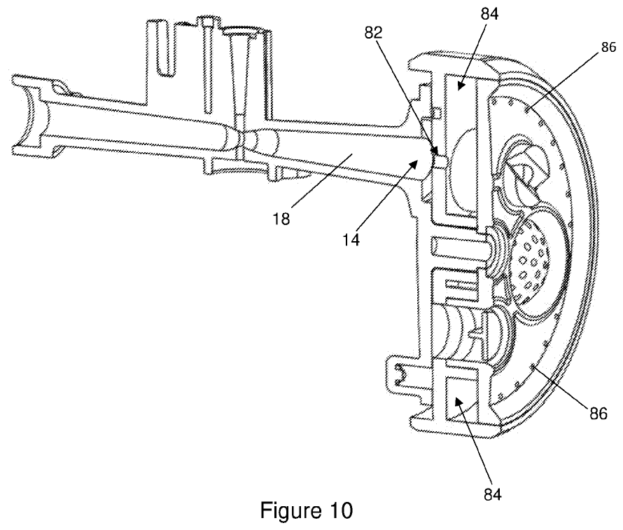

With reference to FIGS. 9 and 10, there is shown a schematic section view of a nozzle assembly 56. The nozzle assembly 56 includes a plurality of vents 80,82. at least one of the vents 80,82 is aligned with an outlet 14 when the nozzles 50,52,54 are partially or not aligned with the outlet 14. FIG. 9 shows a nozzle 50 aligned with the outlet 14. FIG. 10 shows a vent 82 aligned with the outlet 14. The nozzle assembly 56 includes a jacket 84 which is fluidly connected to the vents 80,82. The jacket 84 is in turn fluidly connected to vent openings 86 which enable fluid in the jacket 84 to flow out of the nozzle assembly 56.

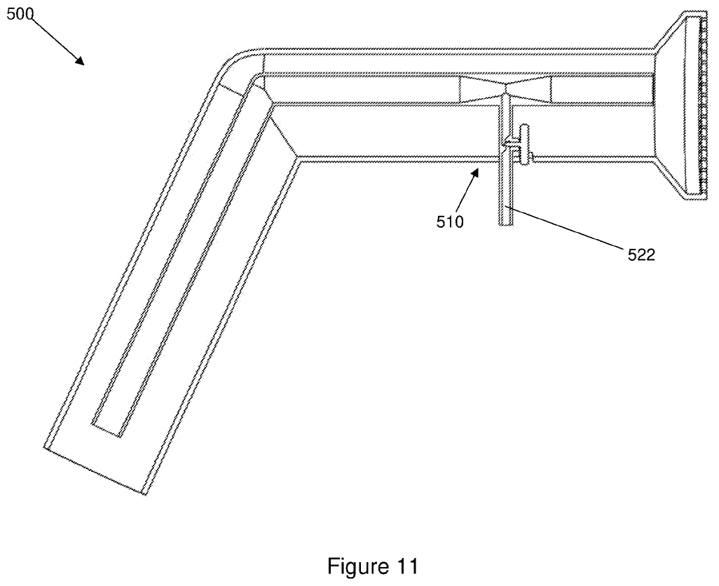

With reference to FIG. 11, there is shown a schematic section view of a sprayer 500 according to an embodiment. The sprayer 500 includes a throttling valve 510. The throttling valve 510 is adapted to control the amount of fluid flow in the second fluid path 522.

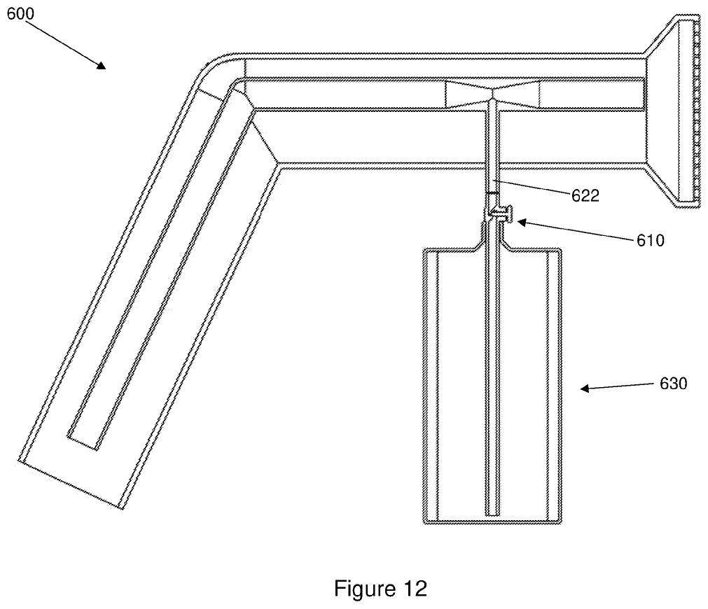

With reference to FIG. 12, there is shown a schematic section view of a sprayer 600 according to an embodiment. The sprayer 600 includes a container 630. A throttling valve 610 is associated with the container 630. The throttling valve 610 is adapted to control the amount of fluid flow from the container 630 to the second fluid path 622.

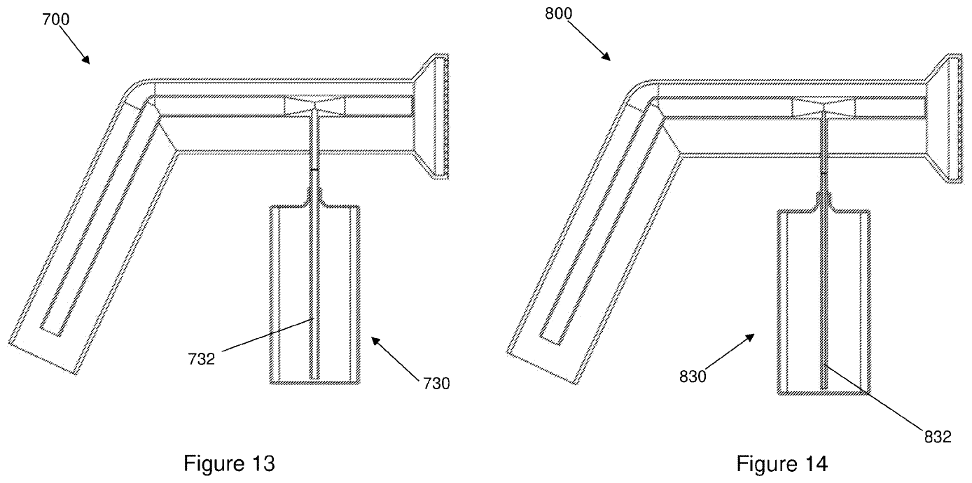

With reference to FIGS. 13 and 14, there are shown two sprayers 700,800 according to embodiments of the present invention. The sprayers 700,800 have containers 730,830. The containers 730,830 have pick up tubes 732,832. Pick up tube 732 has a larger internal diameter than pick up tube 832. The change in diameter can be used to partially control the flow rate of fluid out of containers 730,830.

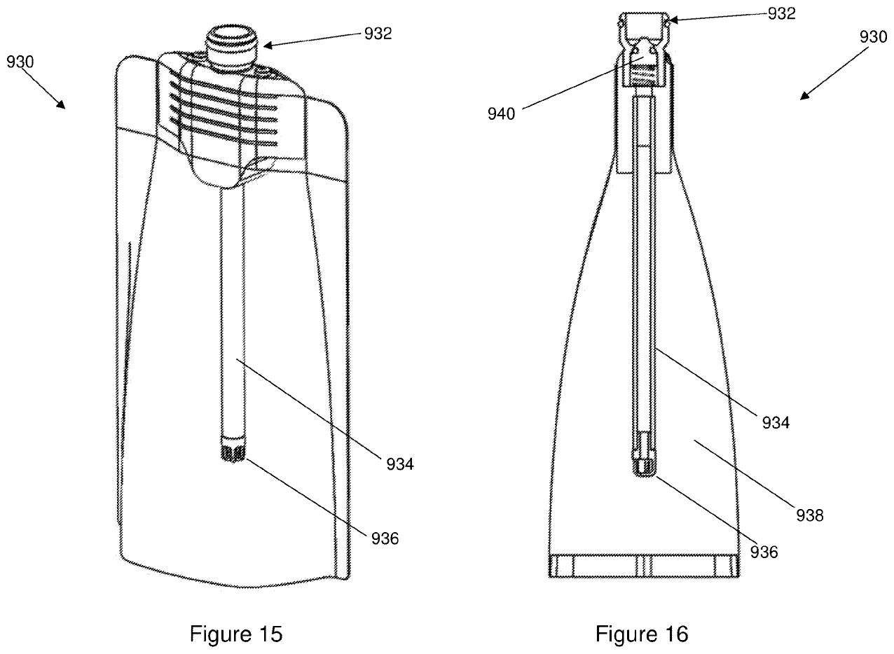

With reference to FIGS. 15 and 16, there is shown a container 930. The container 930 includes a male connector 932. The male connector is fluidly connected to a pick up tube 934. The pickup tube 934 has a suction inlet 936 to enable fluid from an internal space 938 of the container 930 to flow into the pickup tube 934. The container has an anti drip valve 940 located between the male connector 932 and the pickup tube 934. The anti drip valve 940 is biased into a closed position when it is not attached to a sprayer.

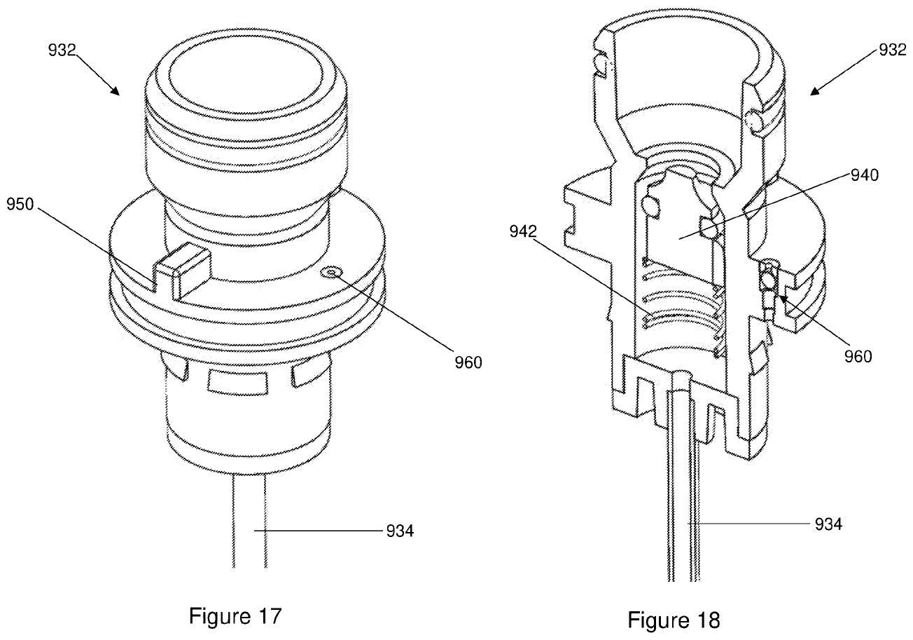

With reference to FIGS. 17 and 18, there is shown the male connector 932 of FIGS. 15 and 16 in more detail. The male connector 932 has an alignment protrusion 950. The male connector 932 has a one way valve 960 to enable air to be introduced into the internal space 938 of the container 930. The anti drip valve 940 is shown in an open condition. The anti drip valve 940 is biased into a closed position (as seen in FIG. 16) by a spring 942.

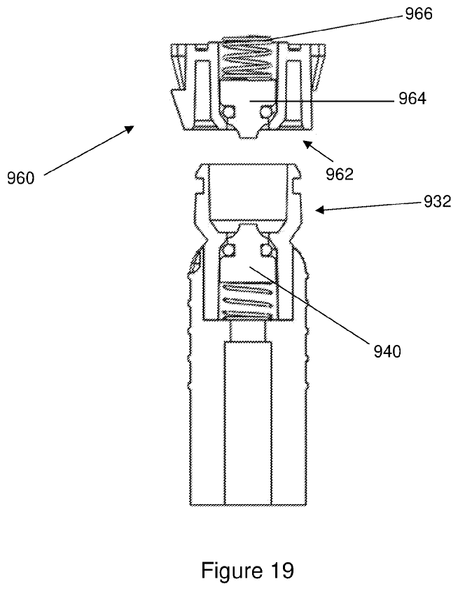

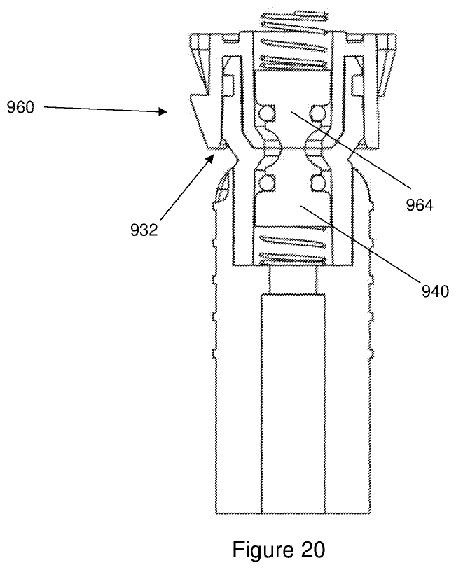

With reference to FIGS. 19 and 20, there is shown the male connector 932 of FIGS. 15 to 18, as well as a portion of a sprayer 960. The sprayer 960 includes a female connector 962 adapted to accept the male connector 932. The sprayer 960 includes an anti drip valve 964. The sprayer 960 includes a spring 966 that biases the anti drip valve 964 to a closed condition (as seen in FIG. 19). FIG. 20 shows the female connector 962 and the male connector 932 engaged. In this configuration, anti drip valve 964 and anti drip valve 940 engage with each other and move each other to an open condition.

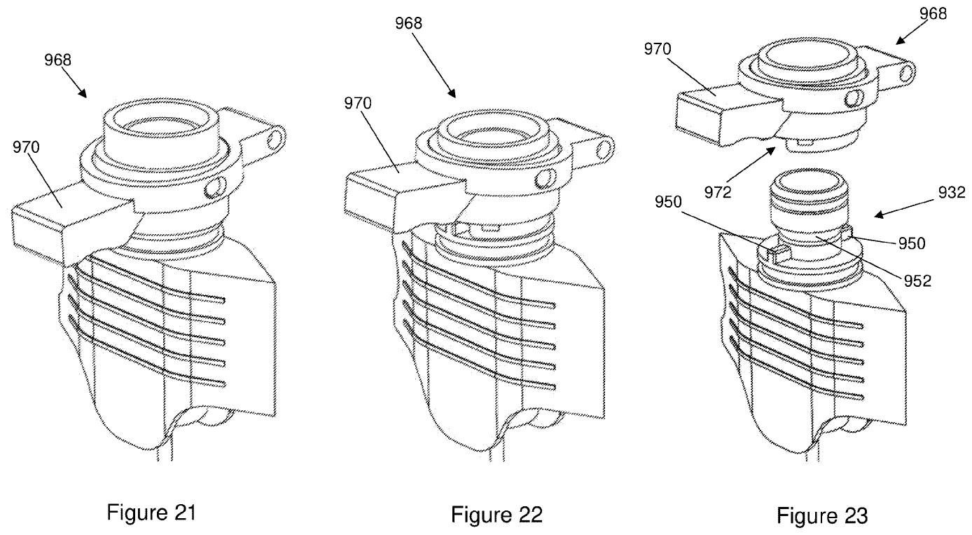

With reference to FIGS. 21 to 23, there is shown a male connector 932 of a container 930 (as seen in FIGS. 15 and 16) and a connector portion 968 of a sprayer (not shown). The connector portion 968 has a lever 970 movable between a secured condition (as seen in FIG. 21) and a release condition (as seen in FIGS. 22 and 23). In the secured condition, a securing member (not shown) of the connector portion engages with a recessed portion 952 to retain the male connector 932 within a female connector 962 (not shown, best seen in FIG. 19) of the connector portion 968. In the release condition, the securing member (not shown) is retracted relative to the recessed portion 952, enabling the male connector 932 to be removed from the female connector 962 (not shown, best seen in FIG. 19). The connector portion 968 has a recess portion 972 which is adapted to align protrusions 950 of the male connector 932.

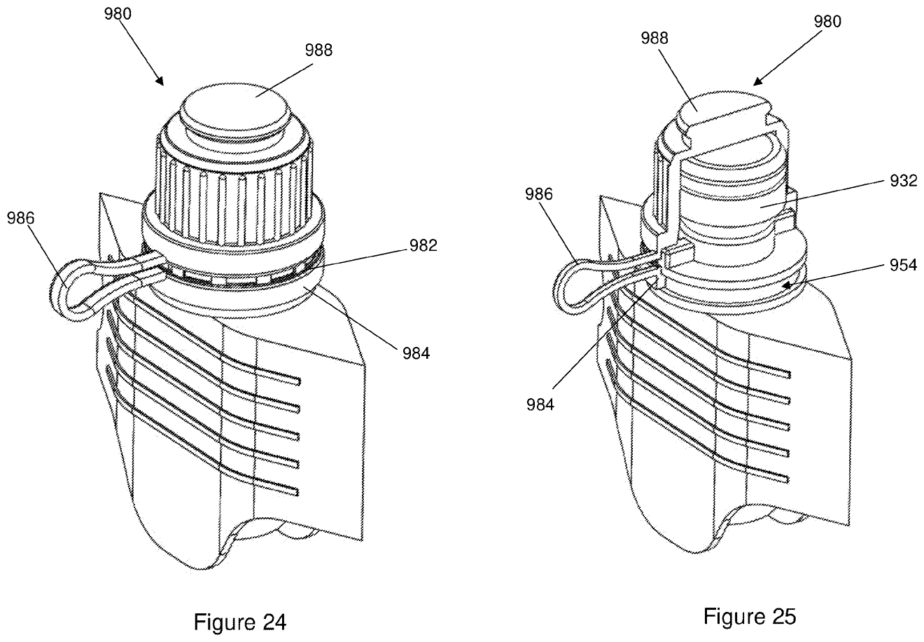

With reference to FIGS. 24 and 25, there is shown a cap 980 for the male connector 932. The cap 980 includes a base portion 984. The base portion 984 engages with a channel 954 of the male connector 932. The cap 980 includes a tamper evident seal in the form of breakable tabs 982. A top portion 988 of the cap 980 is attached to the base portion 984 by a tether 986. In this manner, the top portion 988 can remain connected with the base portion while the top portion 988 is not covering the male portion, such that a container 930 (as seen in FIGS. 15 and 16) can be resealed when not connected to a sprayer (not shown).

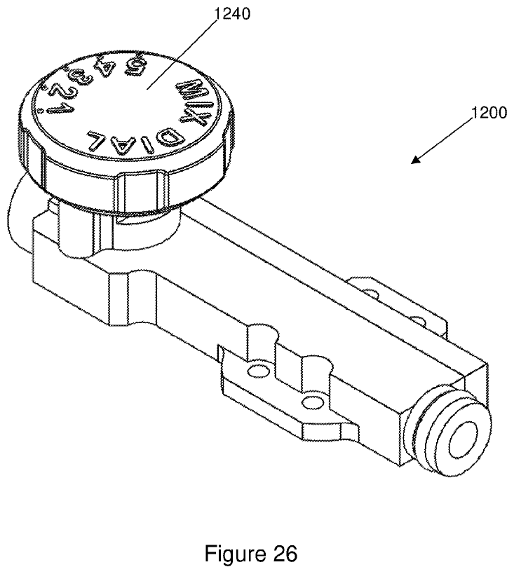

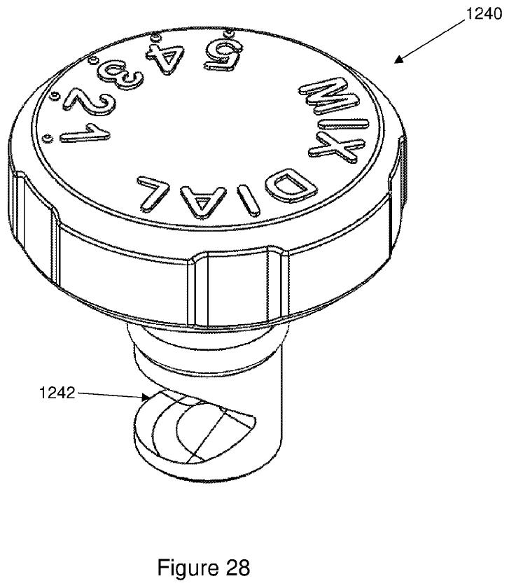

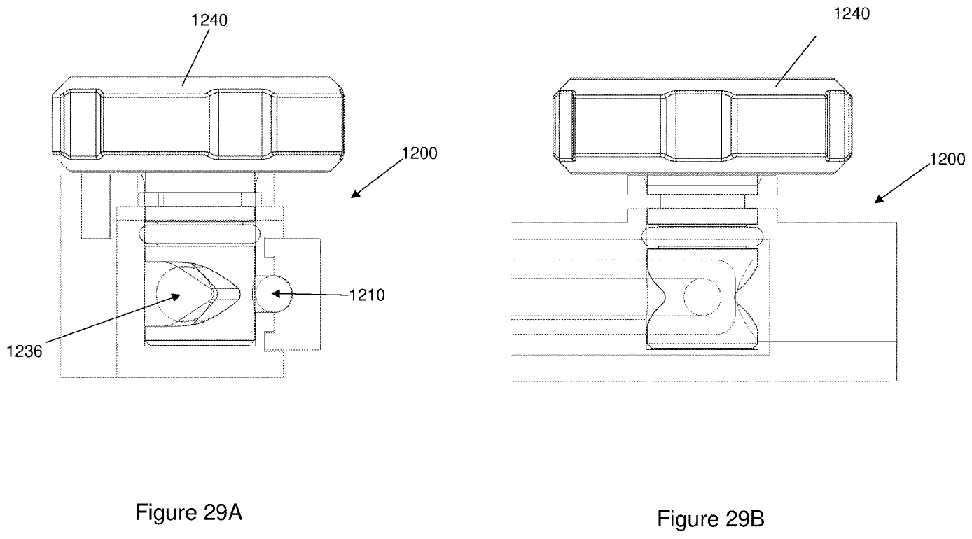

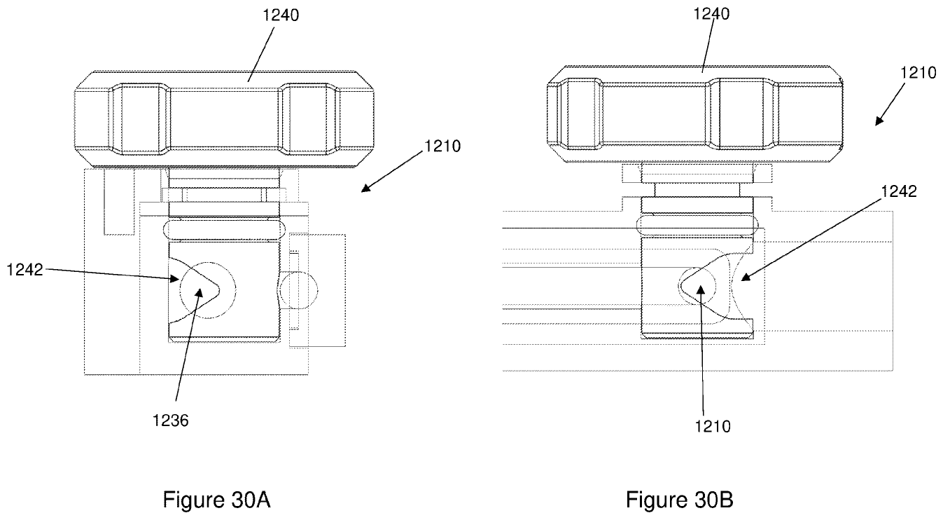

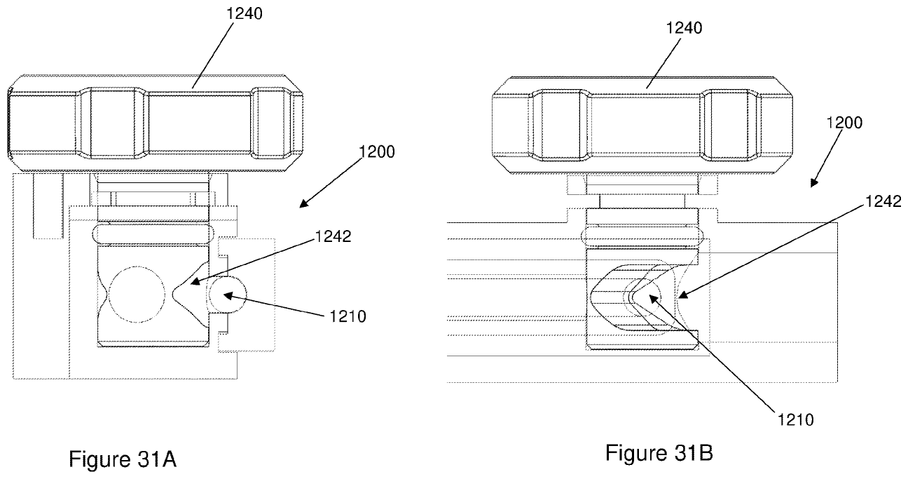

With reference to FIGS. 26 to 31B, there is shown a bypass and venturi arrangement 1200 according to an embodiment of the invention. The bypass and venturi arrangement 1200 has a bypass path 1210. The bypass path 1210 is fluidly attached in front of and behind a venturi arrangement 1236. A third controller 1240 controls the amount of fluid which flows through the venturi arrangement 1236. The third controller 1240 has an aperture 1242, which directs fluid into the bypass path 1210 and/or the venturi arrangement 1236. The third controller 1240 can be adjusted to direct all of the flow of fluid through the venturi arrangement 1236 (as shown in FIGS. 29A and 29B), or a part of the fluid flow through the venturi arrangement 1236 and a part through the bypass path 1210 (as shown in FIGS. 30A and 30B). The third controller 1240 can also be adjusted to direct all of the flow of fluid through the bypass path 1210 (as shown in FIGS. 31A and 31B).

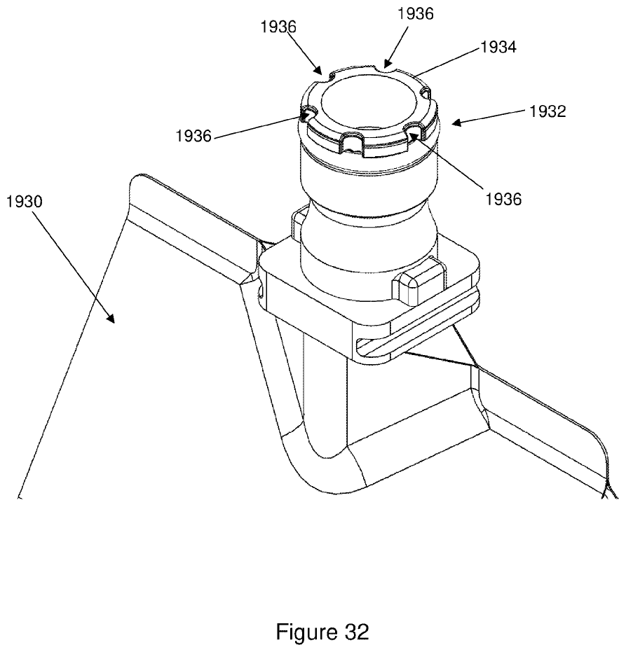

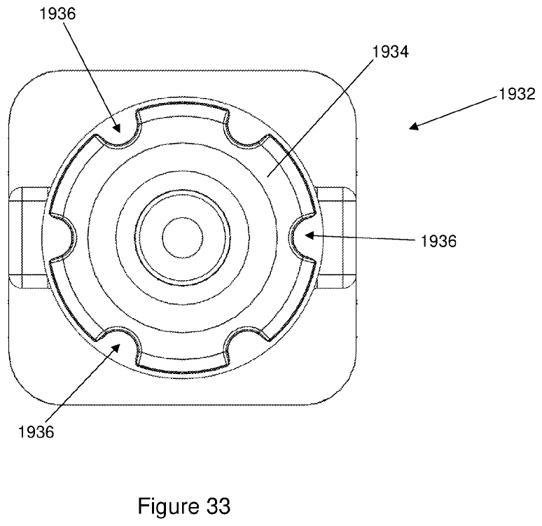

With reference to FIGS. 32 and 33, there is shown a male connector 1932 of a container 1930. The male connector 1932 has a protruding lip 1934. The protruding lip 1934 has a plurality of semi circular recesses 1936 formed therein. The recesses 1936 engage with protrusions (not shown) on the sprayer (not shown) to ensure correct orientation between the container 1930 and the sprayer.

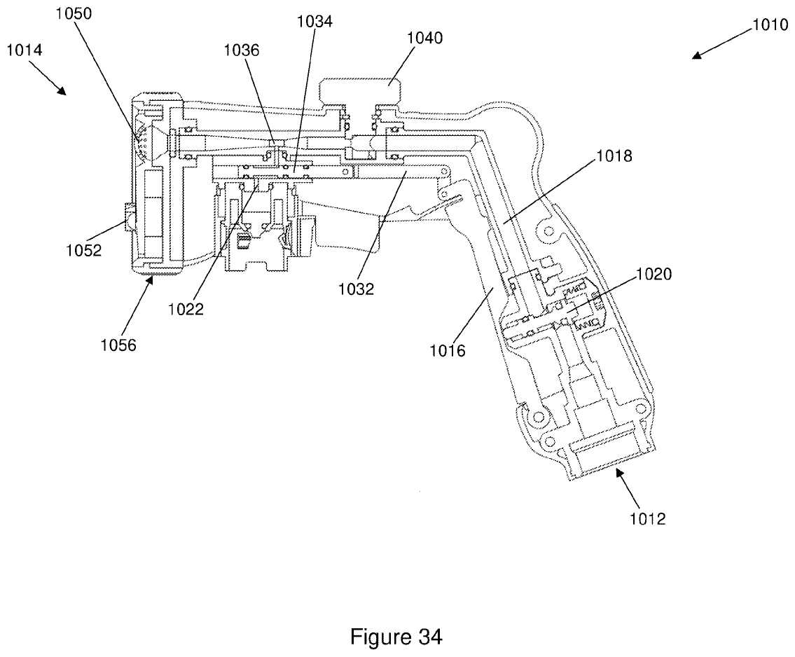

With reference to FIG. 34, there is shown a sprayer 1010 according to a preferred embodiment of the present invention. The sprayer 1010 has an inlet 1012 for introducing water into the sprayer 1010. The sprayer 1010 has an outlet 1014 for discharging fluid from the sprayer 1010. The sprayer 1010 has a first controller 1016 to control the flow of fluid from the inlet 1012 to the outlet 1014. A first fluid path 1018 is located between the first controller 1016 and the outlet 1014. A valve 1020 of the first controller 1016 controls the flow of fluid from the inlet 1012 to the outlet 1014.

A second fluid path 1022 is fluidly connectable to a container (not shown) having an active liquid. A second controller 1032 controls the flow of active liquid in the second fluid path 1022. The second controller 1032 includes a valve 1034 to control the flow of active liquid in the second fluid path 1022. The second controller 1032 is operatively connected to the first controller 1016.

The sprayer 1010 has a venturi arrangement 1036 located in line with the first fluid path 1018. The venturi arrangement 1036 is adapted to introduce active liquid from the second fluid path 1022 into the first fluid path 1018.

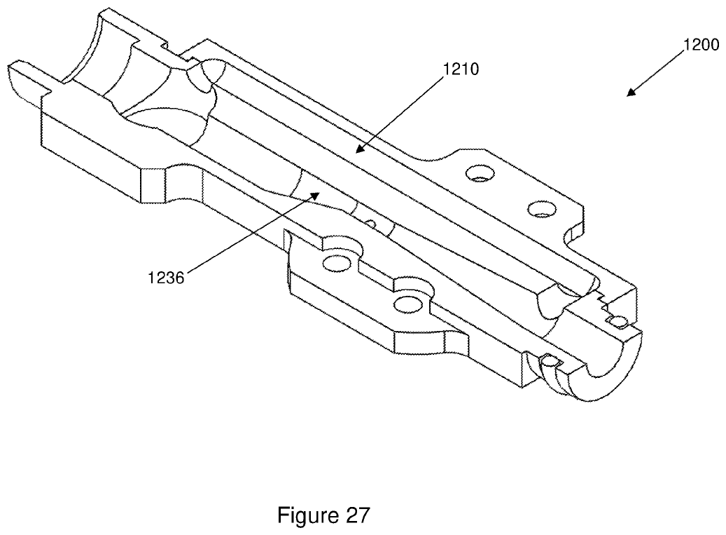

The sprayer 1010 has a third controller 1040 to control the flow of fluid through the venturi arrangement 1036 and/or a bypass path (not shown see for example FIG. 27).

The outlet 1014 includes a plurality of nozzles 1050, 1052 to discharge the fluid. A desired nozzle is selectable from the plurality of nozzles 1050,1052 by twisting the nozzle assembly 1056 relative to the sprayer 1010.

### Advantages

An advantage of the preferred embodiment of the sprayer includes an easier way to control the discharge of active liquid from the sprayer. Another advantage of the preferred embodiment of the sprayer includes the ability to spray water without the addition of active liquid. A further advantage of the preferred embodiment of the sprayer includes the ability to switch to different types of active liquids. Another advantage of the preferred embodiment of the sprayer includes that the plurality of vents reduce the amount of pressure that can build up behind the nozzle assembly.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A sprayer for attachment to a hose, the sprayer comprising:
an inlet configured for introducing fluid into the sprayer;
an outlet configured for discharging fluid from the sprayer;
a first controller to control the flow of fluid from the inlet to the outlet;
a first fluid path located between the first controller and the outlet;
a second fluid path fluidly connectable to a container having an active liquid; and
a venturi arrangement located in line with the first fluid path wherein the venturi arrangement further comprises: a convergent section arranged to receive the fluid from the inlet and converge the received fluid towards a throat section followed by a divergent section that conveys the fluid from the throat section to the outlet, the venturi arrangement being further adapted to introduce fluid from the second fluid path into the throat section of the venturi arrangement thereby introducing the active liquid into the first fluid path; and
a bypass path fluidly connected to the first fluid path before the venturi arrangement and after the venturi arrangement for allowing at least some of the fluid from the inlet to bypass the venturi arrangement and flow towards the outlet.

2. The sprayer as claimed in claim 1 further including a second controller to control the flow of active liquid in the second fluid path.

3. The sprayer as claimed in claim 2, wherein the second controller is actuated by the first controller.

4. The sprayer as claimed in claim 2, or wherein the second controller is operatively attached to the first controller.

5. (canceled)

6. The sprayer in accordance with claim 1 and further comprising: a third controller to control the flow of the fluid through the venturi arrangement.

7. (canceled)

8. The sprayer as claimed in claim 6, wherein the third controller controls an amount of fluid which flows through the bypass path.

9. The sprayer as claimed in claim 8, wherein the third controller is adapted to divert a portion of the fluid through the bypass path, all the fluid through the venturi arrangement, and/or all of the fluid through the bypass path.

10. The sprayer as claimed in claim 1, wherein the sprayer includes the container.

11. The sprayer as claimed in claim 10, wherein the container is a collapsible bladder.

12. The sprayer as claimed in claim 10, wherein the container has one or more locating portions to assist in aligning the container with the sprayer when the container is connected to the sprayer.

13. The sprayer as claimed in claim 12, wherein the one or more locating portions on the container are recesses.

14. The sprayer as claimed in claim 13, wherein the one or more locating portions on the container are semi circular recesses.

15. The sprayer as claimed in claim 1, further including an anti drip valve biased into a closed condition, wherein in the closed condition, the second fluid path is closed, and wherein when the container is connected to the sprayer, the anti drip valve is moved to an open condition such that active liquid can flow from the container to the second fluid path.

16-20. (canceled)
